(19) United States
(12) Patent Application Publication
(10) Pub. No.: US 2022/0358570 A1
(43) Pub. Date: Nov. 10, 2022

(54) DISPLAYING REAL-TIME PURCHASE DECISION CRITERIA IN A VIRTUAL REALITY ENVIRONMENT

(71) Applicant: International Business Machines Corporation, Armonk, NY (US)

(72) Inventors: Tushar Agrawal, West Fargo, ND (US); Clement Decrop, Arlington, VA (US); Jeremy R. Fox, Georgetown, TX (US); Sarbajit K. Rakshit, Kolkata (IN)

(21) Appl. No.: 17/302,595

(22) Filed: May 7, 2021

(51) Int. Cl. G06Q 30/06; G06N 20/00

(52) U.S. Cl. CPC G06Q 30/0643; G06Q 30/0631; G06N 20/00

(57) ABSTRACT

A computer indicates to a user in a virtual reality shopping session, aspects of availability for a selected item. The computer identifies, in a virtual reality (VR) shopping environment, a product selected for consideration by a group of interested shoppers during a VR shopping session, including a user and at least one additional shopper. The computer determines that the product has an available quantity value below a predetermined warning threshold, based at least in part on a comparison of an in-stock quantity of the product and an indicated purchase quantity preference associated with the interested shoppers for the product. In response to the determination, the computer identifies, a product popularity value representing, at least in part, a quantity associated with the group of interested shoppers. The computer displays, in the VR shopping environment to the user, the product popularity value.

### BACKGROUND

The present invention relates generally to the field of using computers to display information in virtual reality environments, and more specifically, to providing purchase-related information to users in a virtual consumer environment.

Interacting with a computer generated, virtual environment that displays items for purchase using a virtual reality display (or similar interface) may be referred to as Virtual Reality (VR) shopping, and discrete shopping experiences may be called VR shopping sessions. During a given VR shopping session, an individual may engage with an online vendor to browse items available for purchase, make comparisons among items of interest, complete item purchases, and so forth.

The virtual reality display may provide a representation of items available for purchase from the vendor (e.g., located in one or more physical warehouses or otherwise available), and the user can make purchases of items through direct interaction with the virtual reality display. In some cases, purchased products are delivered to the user as part of the transaction, and in other cases, products are simply made available for pickup by the user.

### SUMMARY

According to one embodiment, a computer implemented method of indicating to a user in a virtual reality shopping session, aspects of availability for a selected item, includes identifying, in a virtual reality (VR) shopping environment, a product selected for consideration by a group of interested shoppers during a VR shopping session, including a user and at least one additional shopper. The computer determines that the product has an available quantity value below a predetermined warning threshold, based at least in part on a comparison of an in-stock quantity of the product and an indicated purchase quantity preference associated with the interested shoppers for the product. The computer, in response the determination, identifies a product popularity value representing, at least in part, a quantity associated with the group of interested shoppers. The computer displays, in the VR shopping environment to the user, the product popularity value. According to aspects of the invention, the product popularity value further represents the indicated purchase quantity preference. According to aspects of the invention, the product popularity value further includes, a purchase likelihood category associated with the at least one additional shopper. According to aspects of the invention, the product popularity value further includes a purchase probability associated with the at least one additional shopper, the purchase probability is generated by a Machine Learning (ML) model trained to predict shopping activity of interested shoppers applied to shopper history metadata associated with the at least one additional shopper available to the computer. According to aspects of the invention, the computer further displays, in the VR shopping environment to the user, a product stock replenishment date based, at least in part, on supply chain metadata available to the computer. According to aspects of the invention, the computer further presents to the user for consideration, an item identified by the computer as a substitute candidate for the product selected. According to aspects of the invention, the computer further presents to the user an indication of a user relative queue position within the group of interested shoppers. According to aspects of the invention, the computer determines a change to at least one of the available quantity and user relative queue position during the VR shopping session and displays, in the VR shopping environment to the user, an alert indicating the at least one change.

According to another embodiment, a system to indicate to a user in a virtual reality shopping session, aspects of availability for a selected item, which comprises: a computer system comprising a computer readable storage medium having program instructions embodied therewith, the program instructions executable by a computer to cause the computer to: identify in a virtual reality (VR) shopping environment, a product selected for consideration by a group of interested shoppers during a VR shopping session, including a user and at least one additional shopper; determine that the product has an available quantity value below a predetermined warning threshold, based at least in part on a comparison of an in-stock quantity of said product and an indicated purchase quantity preference associated with said interested shoppers for said product; responsive to said determination, identifying a product popularity value representing, at least in part, a quantity associated with said group of interested shoppers; and display in said VR shopping environment to said user, said product popularity value.

According to another embodiment, a computer program product to indicate to a user in a virtual reality shopping session, aspects of availability for a selected item, the computer program product comprising a computer readable storage medium having program instructions embodied therewith, the program instructions executable by a computer to cause the computer to: identify in a virtual reality (VR) shopping environment, a product selected for consideration by a group of interested shoppers during a VR shopping session, including a user and at least one additional shopper; determine that the product has an available quantity value below a predetermined warning threshold, based at least in part on a comparison of an in-stock quantity of said product and an indicated purchase quantity preference associated with said interested shoppers for said product; responsive to said determination, identifying a product popularity value representing, at least in part, a quantity associated with said group of interested shoppers; and display in said VR shopping environment to said user, said product popularity value.

Aspects of the present invention recognize and address a source of VR shopping session frustration, in that many such sessions are conducted without visual cues often present when shopping in a physical, brick-and-mortar store. For example, in a physical store, it can be relatively easy to determine when a product of interest is being concurrently considered by other shoppers (i.e., item popularity during a given shopping session), as those shoppers will often be located near (and will sometimes be interacting with) the product. This kind of real-time item popularity information may help shoppers decide whether (and how soon) to complete a purchase of items, and this information can be especially useful when making decisions about products with low availability. It is possible in a VR shopping session to have a group of shoppers interacting with (e.g., logged into via a network of computers) a single vendor, and members of the group may be considering the same items for purchase concurrently. Groups of networked shoppers may be located remote from one another, and it can be difficult to obtain contemporaneous information regarding product popularity within the group of shoppers, during a VR shopping session. Without this perspective, a selected product may suddenly become unavailable without a user having prior warning. Aspects of the present invention note when available quantities for a product of interest are running low (e.g., a “low availability” item or product) and indicate a quantity of shoppers concurrently interested in the produce (i.e., an indication of item popularity among other shoppers during a given shopping session) to the user. This information gives a user an appreciation of the current popularity of low availability products among other concurrent shoppers, allowing the user to strategically expedite (or, in some cases, delay) selected VR shopping purchases.

In addition to information about a quantity of shoppers considering items of interest to the user, aspects of the invention provide qualitative information (e.g., expected shopping behavior) about other shoppers contemporaneously considering (i.e., during a current shopping session) items of interest to the user. In an embodiment, the invention provides an indication of a likelihood that other identified shoppers will purchase items being considered. In an embodiment, the sever computer considers attributes of concurrent shoppers, including historic, per-shopper purchasing tendencies available to the server computer (e.g., whether historically, a given shopper tends to browse rather than purchase, tends to browse and then purchase in some cases, tends to browse and then usually purchase, and so forth) and presents the user with a concurrent shopper predicted purchase likelihood. In an embodiment, the computer categorizes shoppers as low purchase probability shoppers, medium purchase probability shoppers, or purchase probability shoppers. In an embodiment, the server computer determines a purchase likelihood percentage value to shoppers for whom a known purchasing trend is available (e.g., from shopper history metadata), and this percentage value is provided to the user. This predicted purchase likelihood information extends user perspective beyond that which is typically available when shopping in a brick and mortar store.

Aspects of the present invention provide information regarding a customer's relative position in a virtual queue of shoppers considering a particular item at the same point of time (e.g., concurrent shoppers).

Aspects of the invention recognize and address a need to help VR shoppers understand product current supply and demand conditions for given items, so shoppers can make informed decisions about whether and when to purchase items having high popularity and low availability during a given virtual shopping session.

According to aspects of the invention, products will be arranged in a VR shopping environment according to product availability. In an embodiment, products are located on shelves in a way that indicates product availability (e.g., some shelves indicate in-stock or otherwise available items, while other shelves indicate items that are out of stock, are on order, or otherwise not currently available).

Aspects of the present invention consider available physical stock (e.g., an in-stock quantity) for an item, along with a quantity of customers currently considering (e.g., have the item in a cart, in an active search list, a saved items, and similar indications) the item and provides information about virtual queue related to the item (e.g., if four units of an item are currently available and four shoppers have indicated an interest in the item before the user indicates interest, aspects of the system would show the user (e.g., a fifth interested shopper) the quantity available and the number of shoppers already indicating an interest. Depending on shopping system preferences (e.g., if the queue represents a series-based, hierarchical purchase option order, the user might need to wait for the shoppers currently queued up to decide before being able to purchase the item. In other arrangements, where purchasing ability is not dependent on queue position, the information provided by aspects of the present invention may allow a user to accelerate a purchasing decision to buy a product before available stock is depleted.

Aspects of the system will consider attributes, including purchasing tendencies, associated with currently-interested shoppers and indicate a likelihood of stock being depleted by the current group of shoppers.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of an automated system to help a virtual reality shopper make time-sensitive purchasing decisions regarding low-availability items of contemporaneous interest to other shoppers according to embodiments of the present invention.

FIG. 2 is a flowchart illustrating aspects of a method, implemented using the system shown in FIG. 1, of helping a virtual reality shopper make time-sensitive purchasing decisions regarding low-availability items of contemporaneous interest to other shoppers according to aspects of the invention.

FIG. 3 is a flowchart illustrating aspects of a method, implemented using the system shown in FIG. 1, of helping a virtual reality shopper make time-sensitive purchasing decisions regarding low-availability items of contemporaneous interest to other shoppers according to aspects of the invention.

FIG. 4A is a schematic representation of aspects of a Virtual Reality (VR) shopping ecosystem, including supply chain elements, an interactive display, and a user, according to aspects of the invention.

FIG. 4B is a schematic representation of aspects of a Virtual Reality (VR) shopping ecosystem, including an alert message provided to a user, according to aspects of the invention.

FIG. 5 is a schematic representation of aspects of a product considered for purchase in a Virtual Reality (VR) shopping ecosystem presented to a user, according to aspects of the invention.

FIG. 6 is a schematic representation of aspects of a VR shopping ecosystem using elements of the system shown in FIG. 1 to help a virtual reality shopper make time-sensitive purchasing decisions regarding low-availability items of contemporaneous interest to other shoppers according to aspects of the invention.

FIG. 7 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 8 depicts a cloud computing environment according to an embodiment of the present invention.

FIG. 9 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

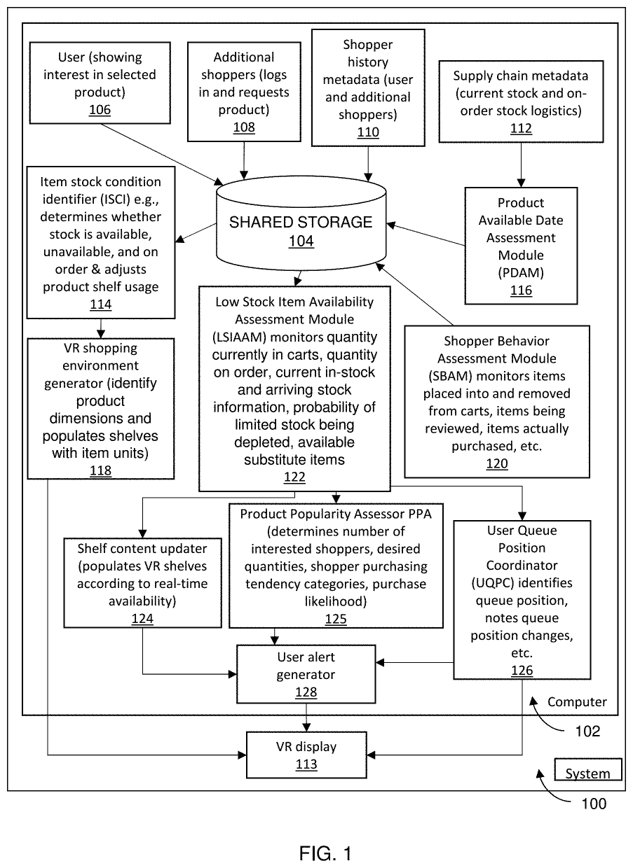

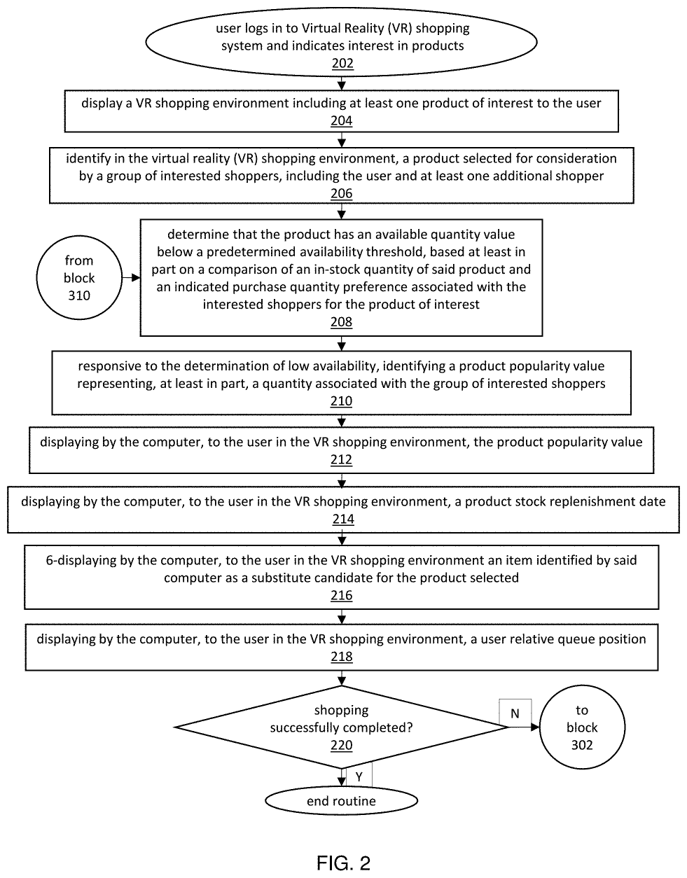

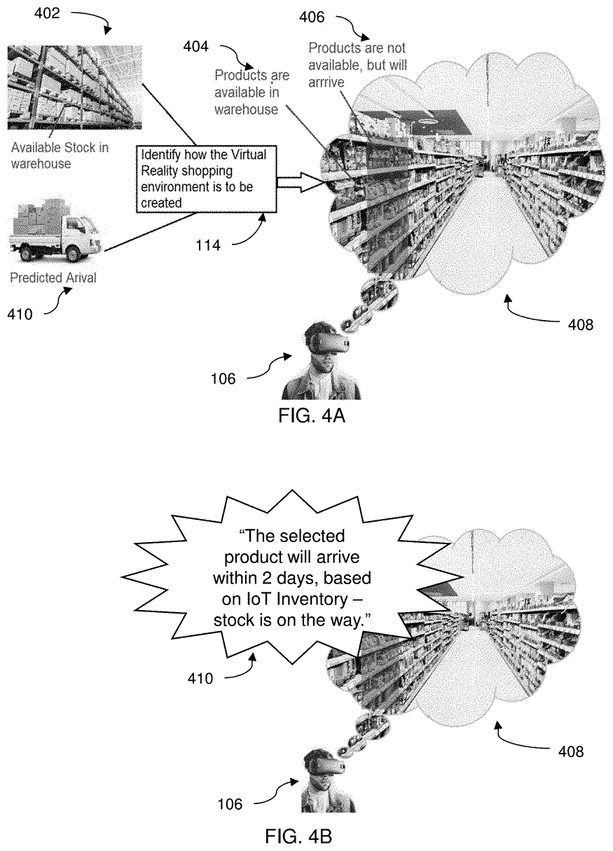

Now with combined reference to the Figures generally and with particular reference to FIG. 1 and FIG. 2, an overview of an automated method of displaying information to a virtual reality shopper relevant to time-sensitive purchasing decisions regarding low-availability items of contemporaneous interest to other shoppers usable within a system 100 as carried out by a server computer 102 having optionally shared storage 104 will be described. The server computer 102 is in operative communication with a user 106 (e.g., a Virtual Reality (VR) shopper who has expressed an interest in one or more selected products). According to aspects of the invention, the server computer 102 is in communication with a group of additional shoppers 108 (e.g., one or more contemporaneous VR shoppers logged in or otherwise interacting with the system 100 while the user 106 is shopping). According to aspects of the invention, the group of shoppers 108 is shopping concurrently within a shared stock of products (e.g., one or more vendor warehouses 402 (e.g., as shown in FIG. 4A), the contents of which are represented by warehouse contents and associated supply chain metadata 112.

The server computer 102 is in communication with a source of shopper history metadata 110 (e.g., information stored in association with shopper buying patterns, such as items bought as part of a customer loyalty program or other similar opt-in purchase tracking arrangement). The server computer 102 is connected to a source of supply chain metadata 112 (e.g., information about current stock and on-order stock logistics) that, as noted above, is associated with one or more warehouses 402 containing products available to the shoppers 106,108.

The server computer 102 includes Item Stock Condition Identifier (ISCI) 114 that determines for items in (and heading toward) warehouses 402 supplying the VR shopping session, whether items are available 404 or unavailable 406. The ISCI 114 also determines whether unavailable items are on order and establishes appropriate product virtual shelf 404, 406 usage.

According to aspects of the invention, the item availability is represented in virtual shopping environment 408 (e.g., as seen in FIG. 4A) presented to the user 106 via a VR headset 113 (or other similar display interface selected by one skilled in this field). The server computer 102 includes Product Available Date Assessment Module (PADAM) 116 that uses supply chain metadata 112 to determine a predicted arrival date for on-order products 406. According to aspects of the invention, the PADAM 116 uses regression techniques (e.g., linear regression or other suitable method selected by one skilled in this field) to estimate a product arrival date, based for example, on expected transit times and current item location. In an embodiment, the user 106 is requesting item delivery, and a delivery date is provided. In an embodiment, the user 106 is requesting item pickup, and an item pickup date is provided.

The server computer 102 includes VR shopping environment generator 118 that identifies product dimensions (e.g., display footprint associated with products within the VR shopping environment 408, based on product availability) and populates virtual shelves 404, 406 with item units as appropriate. According to some aspects of the invention, representations of unavailable products 406 may be shown with an indication that although the product is currently unavailable, it is on order and will be available on a predicted arrival date (as shown in arrival message 410 shown in FIG. B). In an embodiment, products that are unavailable are absent from the virtual environment 408. In an embodiment, products are located on shelves in a way that indicates product availability (e.g., some shelves 404 indicate in-stock or otherwise available items, while other shelves 406 indicate items that are out of stock, are in transit to a warehouse, or are otherwise not currently available).

The server computer 102 includes Shopper Behavior Assessment Module (SBAM) 120 that monitor activities of shoppers relevant to the availability of the items of interest to the user 106 (e.g., interested shoppers placing an item in a virtual cart, reviewing the item, removing an item from a cart, purchasing the item, and so forth). The server computer 102 includes Low Stock Item Availability Assessment Module (LSIAAM) 122 that monitors information from the ISCI 114, PDAM 116, and SBAM 120 to identify details that affect availability of items of interest to the user 106 (e.g., quantity of item currently in the carts of interested shoppers 106,108, quantity of items of interest on order, on-hand stock for items of interest, supply chain position for arriving stock, and so forth).

According to aspects of the invention, the LSIAAM 122 identifies items of interest to the user 106 and at least one additional shopper 108. In an embodiment, the LSIAAM 122 determines when a selected item of interest has an available quantity value below a predetermined warning threshold and items with quantities below this preset threshold are identified as low-availability items. The available quantity value for an item is the difference between a quantity available in an associated warehouse 402 and the total purchase preference indicated by interested shoppers 106,108. According to aspects of the invention, if a user 106 indicates a need to have the product later than the current date, the available quantity value may be adjusted to account for on-order stock units that are expected to be available 406,410 on the date indicated by the user 106.

According to aspects of the invention, the warning threshold is a percentage (e.g., 10% of total stock capacity) or a discrete value (e.g., such as 5 units). It is noted that the threshold may be adjusted to accommodate aspects of the selected item (e.g., in accordance with the judgment of one skilled in this field, the warning threshold may be decreased for high cost items and items that are known to be slow selling items, while the threshold may be increased for low-cost items and items that are known to sell quickly).

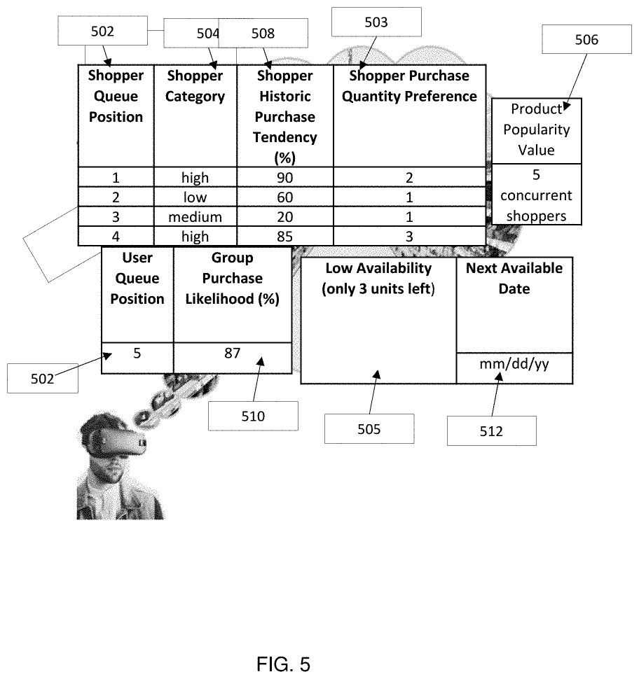

According to aspects of the invention, LSIAAM 122 includes aspects (e.g., a Machine Learning (ML) model trained to predict item interaction outcomes based on prior shopper history, such as that included in supply chain metadata 112) that determine a likelihood of available stock being purchased by interested shoppers 108, and this percentage is indicated (e.g., as 510 in FIG. 5) in the VR shopping environment 408 and may be reflected in the available quantity value for a given item. According to aspects of the invention, the LSIAAM 122 includes information about available substitute items (not shown) and notes these in the VR shopping environment when available as an additional purchase option for a user 102 when considering items of interest having low availability.

The server computer 102 includes shelf content updater 124 that notes changes in item availability (e.g., due to stock arrival, units being sold, etc.) and adjusts virtual shelf content 404,406 accordingly. The shelf content updater 124 registers low availability status for items of interest when identified by LSIAAM 122, and this condition is noted in the VR shopping environment 408 display shown in the user VR display 113.

The server computer 102 includes a Product Popularity Assessor (PPA) 125 that notes the quantity of shoppers concurrently considering items of interest to the user 106. Aspects of the invention indicate this quantity of interested shoppers 106,108 to the user. In an embodiment, the indication of product popularity represents an item purchase quantity indicated by the interested shoppers 106,108.

The server computer 102 includes User Queue Position Coordinator (UQPC) 126 that identifies a queue position 502 (e.g., as shown in FIG. 5) for the user 106 relative to additional shoppers 108 considering items of interest to the user. In some shopping ecosystems, queueing up is a hierarchical, series-based activity, in which entering a line before other shoppers will allow earlier shoppers to make decisions that are not affected by interests of shoppers arriving later. In other systems, queuing up is a flat activity, done in parallel with other interested shoppers, and the any shopper may purchase items and deplete available supply 404 to such a degree that earlier-arriving shoppers are not able to obtain quantities desired.

According to aspects of the present invention, the server computer (e.g., including UQPC 126) presents to a user 106 information regarding queue position 502 (for example, ordinal numbers, such as 1, 2, 3, etc. or ordinal words, such as “first”, “second”, “third”, etc.) in series based queues; and fractional indicators, such as “first out of three” and so on in parallel arrangement queues). According to aspects of the invention, the UQPC 126 may indicate situations in which a user is part of a group of interested shoppers that has an indicated desire for more units of an item than are available. In such cases, the user queue position indication 502 may show that the user holds a queue position of five, when only four units of the selected item are available (e.g., queue position is “5 out of 4 available” or similar message indicating that the present stock may not satisfy the indicated quantity purchase preferences of currently-interested shoppers.

It is noted that the available quantity for a given item of interest may change for a variety of reasons during a given VR shopping session. For example, some interested shoppers 108 may not purchase items for which they have shown interest (e.g., shoppers may remove items being held in virtual carts, may choose to purchase substitute items, and may purchase more (or fewer) units of the item than expected) and on-order stock 406 may arrive. The server computer 102 includes a user alert generator 128 that will generate messages to update a user 106 when an available quantity for items of interest changes.

The user alert generator 128, in cooperation with the ISCI 114, SBAM 120 and LSIAAM 122, would note when events that impact item availability (e.g., like those described above) occur and produce an associated alert 410 (e.g., as shown in FIG. 4B) for the user 106. It is also noted that more interested shoppers 108 may join the queue and others may leave the queue. The server computer 102, via the UQPC 126 and user alert generator 128, will provide appropriate alerts to update the user 106 about such queue changes.

Now with specific reference to FIG. 2, and to other figures generally, an automated method of using the system 100 described above to help a virtual reality shopper make time-sensitive purchasing decisions regarding low-availability items of contemporaneous interest to other shoppers will be described. The server computer 102 at block 202, identifies a user 106 that is logged into a Virtual Reality (VR) shopping system 100 and is indicating interest in products (e.g., such as through interaction with the representations of items in a VR display 113 or other similar interface).

The server computer 102, at block 204 displays a VR shopping environment 408 including at least one product of interest to the user 106 (e.g., as indicated by user activity noted by the server computer 102 via shopper behavior module 120. According to aspects of the invention, the server computer 102 produces the content of the VR shopping environment 408 through cooperation of system elements, including the item stock condition identifier (ISCI) 114 and the VR shopping environment generator 118, and delivers the content to a user 106 via VR headset (or similar display) 113.

The server computer 102, via Shopper Behavior Assessment Module (SBAM) 120 at block 206, identifies within the virtual reality (VR) shopping environment (e.g., a network linking the shoppers 106,108 an allowing them to shop among products in associated warehouses 402), a product selected for consideration by a group of interested shoppers (including the user 106 and at least one additional shopper 108). In particular, the SBAM 120 monitors items placed into and removed from carts, items being reviewed, items purchased and so forth to determine if items of interest to the user 106 are also items of interest to additional shoppers 108, as well as a preferred purchase quantity 503 (e.g., as shown in FIG. 5).

The server computer 102, via Low Stock Item Availability Assessment Module (LSIAAM) 122 at block 208, determines whether the selected product of interest has an available quantity value below a predetermined warning threshold, based at least in part on a comparison of an in-stock quantity of the product and a purchase preference quantity 503 indicated by the interested shoppers 108. According to aspects of the invention, the LSIAAM 122, monitors substantially real-time empirical data to identify availability conditions surrounding the items of interest to the interested shoppers 106, 108. In particular, the LSIAAM 122 notes details about the presence of the selected item of interest within the VR shopping ecosystem, including quantity of the selected item currently in carts, a quantity on order, current in-stock and arriving stock information, available substitute items, and so forth. With these details, the LSIAAM 122 identifies as low availability items, those items of interest for which the available quantity 505 is below an established warning threshold level. According to aspects of the invention, the server computer 102 indicates characteristics of this condition for relevant items within the VR shopping environment.

The server computer 102, via Product Popularity Assessor (PPA) 125 at block 210 will, in response to determining an item of interest to several shoppers 106,108 is a low availability item, display in the VR shopping environment, a product popularity value 506. In an embodiment, the product popularity value 506 represents the number of shoppers 106,108 concurrently considering the items of interest as purchase options. According to aspects of the invention, the quantity of interested shoppers indicated need not include the user 106. In an embodiment, the product popularity value 506 includes an indicated purchase quantity preference expressed by interested shoppers (e.g., by placing a quantity of the selected item into a virtual shopping cart, etc.). In an embodiment, the invention, the PPA 125 categorizes 504 shoppers as being low purchase probability shoppers, medium purchase probability shoppers, or high purchase probability shoppers, based on shopper history metadata 110, and these categorizations 504 are presented to the user and may be represented in the product popularity value 506. It is noted that shopper purchase tendency categories 504 may be included as part of shopper history metadata 110 for some shoppers. It is also noted that shopper purchase tendency categories 504 may be assigned based on computed purchase percentages associated with some shoppers 108 (e.g., a shopper with a computed purchase percentage below 30% is a low purchase probability shopper, a shopper with a computed purchase percentage below 70% is a medium purchase probability shopper, and a shopper with a computed purchase percentage below 70% or above is a low purchase probability shopper). In an embodiment, the server computer 102 determines the purchase likelihood percentage value 508 noted above and associated with shoppers for whom a known purchasing trend is available (e.g., from shopper history metadata). Aspects of the invention present this percentage value to the user 106. According to aspects of the invention, the purchase likelihood percentage value 508 represents the percentage of items purchased after being placed in an online shopping cart (or other historic shopping performance metric selected by one skilled in this field) associated with the shopper, as indicated by associated shopper history metadata. The server computer 102, at block 212, displays the product popularity value 506 to the user 106 in the VR shopping environment 408.

According to aspects of the invention, the product popularity value can consider a historic purchase percentage (e.g., a likelihood of purchase for each shopper and also an overall group purchase likelihood), such as a calculated value based on individual shopper tendencies and associated purchase preferences (e.g., obtained by multiplying a shopper purchase preference 503 by the shopper purchase tendency percentage 508 and calculating the result sum 510 over the current group of interested shoppers 108). It is noted other methods to determine a group purchase likelihood value may be selected by one skilled in this field.

According to aspects of the invention, the server computer 102, via User Queue Position Coordinator (UQPC) 126 determines an initial user queue position (e.g., “first”, “second”, “third”, etc. in series based queues; and fractional indicators, such as “first out of three” and so on in parallel arrangement queues), and the server computer 102 will include this information 502 as a way of providing an indication of product popularity (e.g., a longer line indicates more interest, and being further from the front in a series based queue may indicate to a user that there is a low likelihood being able to purchase the item of interest. In parallel (i.e., non-hierarchical) queues, seeing a large number of additional shoppers may spur a user to accelerate a buying decision to prevent stock from being depleted before the user has made a purchase decision. The UQPC 126 may help a user 102 make a time-sensitive purchase decisions, by providing a level of situational awareness (e.g., how many other shoppers are interested in an item and how close is the item to being out of stock) often present in the physical store aisles and shelves of brick and mortar stores, yet which is typically unavailable in VR settings. In an embodiment, the user queue position 502 indication is updated throughout a given VR shopping session.

The server computer 102, at block 214 indicates in the VR shopping environment 408, a product stock replenishment date 406 (e.g., as shown in FIG. 4A) based, at least in part on the product available quantity and a purchasing tendency associated with the interested shoppers. According to aspects of the invention, the server compute 102 gathers information from various components, including the Product Available Date Assessment Module PADAM 116, the Low Stock Item Availability Assessment Module (LSIAAM) 122, and the shopper history metadata 110 to estimate when an item of interest will be available to the user 106 for purchase. According to aspects of the invention, known shopper purchasing tendencies 508, may be included in the shopper history metadata 110 (e.g., including a history of shopping sessions in which no items were purchased, a history of shopping sessions in which items were put into a cart and not purchased, a history of items previously purchased, and so forth).

The server computer 102, at block 216 displays in the VR shopping environment 408, to the user in the VR shopping environment an item identified by said computer as a substitute candidate for the product selected.

The server computer 102, at block 218 displays in the VR shopping environment 408, to the user in the VR shopping environment a user relative queue position 502. The queue position indicates how many other shoppers 108 are interested in the product being considered by the user 106.

It is noted that, in some cases, the available stock currently in warehouses 402 for a given product will satisfy the purchase needs of a user and other shoppers 108 having contemporaneous interest in the product, and the product availability date is simply the current date. In other cases, the on-hand stock 402 for an item of interest does not meet the purchase quantity preferences of interested shoppers 106,108, and the server computer 102 will calculate a product availability date. According to aspects of the invention, the product availability date will be based on a variety of factors, including a quantity of interested shoppers, and the purchasing tendency of shoppers 106,108 with a known history (e.g., such as those participating in a customer loyalty program or similar opt-in purchase tracking arrangement). In an embodiment, the LSIAAM 122 includes elements (e.g., a Machine Learning (ML) model trained to predict item interaction outcomes based on known shopper history included in shopper history metadata 110) that determine a likelihood of available stock being purchased by interested shoppers 110. This likelihood may be represented as a supplemental information (e.g., as a discrete percentage) associated with items of interest in the VR shopping environment 408 and may also be reflected in the available quantity value for those items. Although this information may be provided for all items of interests, it is especially helpful when a user 106 is considering items with low availability, as it can help the user decide whether and when to make purchases of products that might be known as difficult to obtain. According to aspects of the invention, the LSIAAM 122 includes information about available substitute items (not shown). When appropriate, the server computer 102 indicates the availability of substitute items within the VR shopping environment 408, as additional purchase options for a user 102 to consider.

In cases where a user 106 wants an item that is not currently available, the user may not be able to successfully conclude the shopping exercise during an initial shopping phase. Aspects of the invention (e.g., via the user alert generator) will allow a user to request notification regarding changes in availability. For example, if a selected item is not available (e.g., one or more prior shoppers are currently considering the product in a hierarchical shopping system, no units of the item are currently in stock, etc.) and the item later becomes available (e.g., the number of interested prior shoppers changes or units of replenishing stock arrive), then aspects of the invention will notify the user of these changes, allowing the user to again consider purchasing the item when it is again available. In particular, elements of the invention accommodate a shopping session that extends into a secondary phase prompted by alerts requested by the user 106. The server computer at block 220 determines whether a user 106 has successfully concluded shopping (e.g., whether the user was able to a purchase all items of interest at preferred quantity levels).

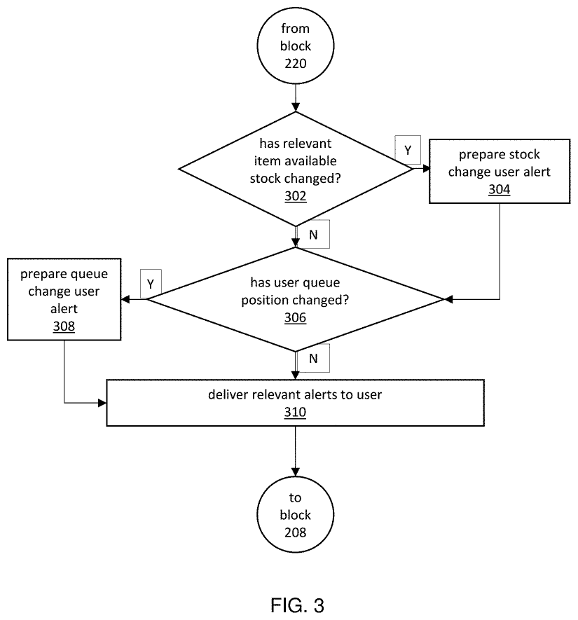

If user shopping did not conclude successfully, control is directed to the user alert generator 128, aspects of which are shown schematically in FIG. 3, discussed in detail here. The server computer 102 determines at block 302 whether available stock quantities of a relevant item (e.g., a selected item with limited availability) have changed since last determined by the LSIAAM 122. If relevant stock has changed, the server computer 102 prepares an appropriate user alert at block 304, and flow continues to block 306. If relevant stock has remained the same, flow moves directly to block 306.

The server computer 102 determines at block 306 whether the position of the user 106 within the queue associated with an item of interest with low availability has changed since last computed by the UQPC 126. If the relevant user queue position 502 has changed, the server computer 102 prepares an appropriate user alert at block 308. The server computer 102 at block 310 delivers relevant user alerts 410 (e.g., as shown in FIG. 4B) to the user display 113, and control returns to block 208. Once the server computer 102 determines that a user 106 has successfully completed shopping (or if the user decides to stop shopping), the server computer 102 concludes the VR shopping session.

Now with reference to FIG. 5, aspects VR shopping ecosystem using elements of the system shown in FIG. 1 are shown schematically. The server computer 102 identifies at 502 a user opting into a VR shopping module. The server computer 102 creates a VR store at block 504. The server computer 102 collects user shopping habits (e.g., via customer loyalty or similar opt-in program). The server computer 102 calculates current product inventory and predicts incoming inventory levels at block 508. The server computer 102 shows information relevant to limited stock items (e.g., limited stock warnings, predictions of stock arrival, alerts about contemporaneous shoppers, likelihood of items being purchased, etc.) at block 510. The server computer 102 notifies a user regarding a position within a queue for items of interest with low availability (e.g., limited stock products).

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

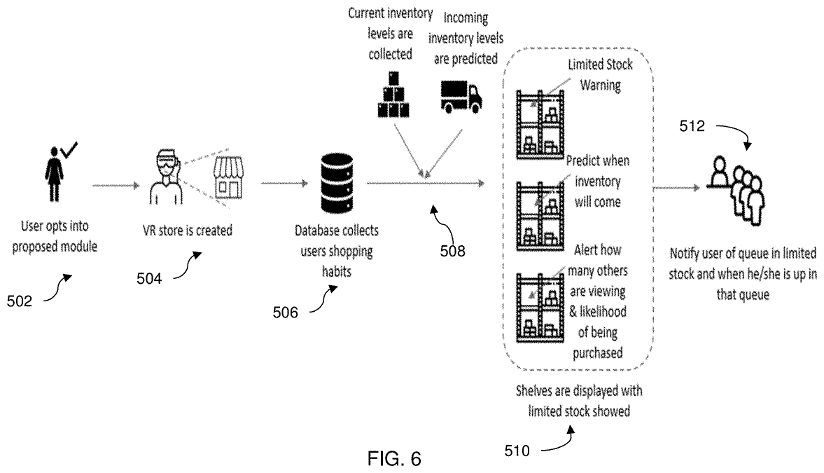

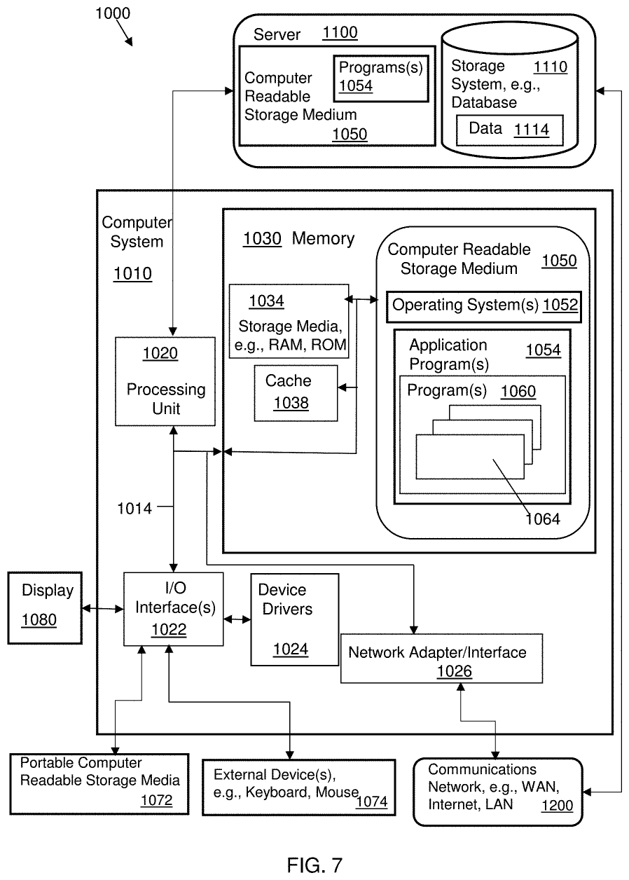

Referring to FIG. 6, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

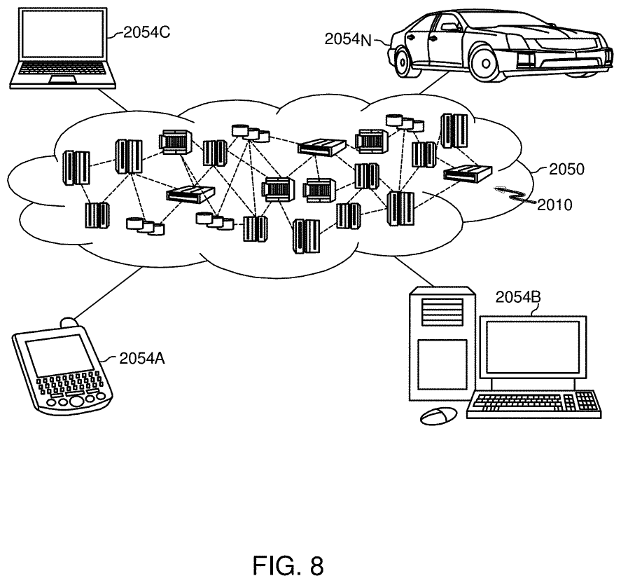

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 8 are intended to be illustrative only and that computing nodes 2010 and cloud computing environment 2050 can communicate with any type of computerized device over any type of network and/or network addressable connection (e.g., using a web browser).

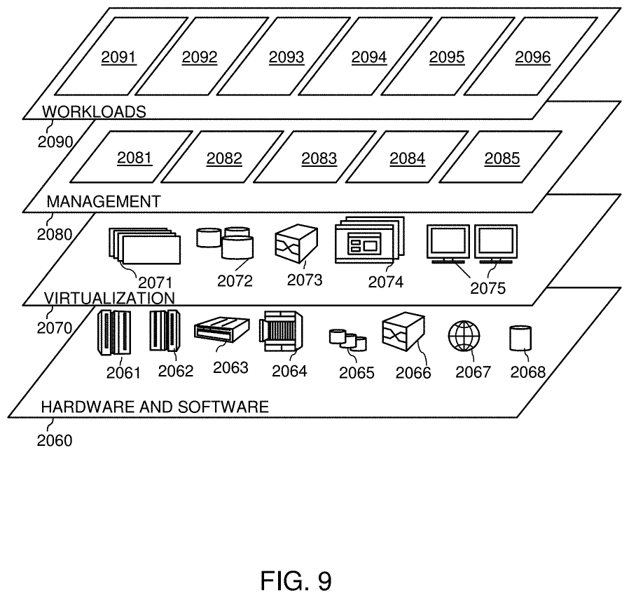

Referring now to FIG. 9, a set of functional abstraction layers provided by cloud computing environment 2050 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and an automated method of providing real-time availability information for low-availability items in a VR shopping environment 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of indicating to a user in a virtual reality shopping session, aspects of availability for a selected item, comprising:
identifying by a computer, in a virtual reality (VR) shopping environment, a product selected for consideration by a group of interested shoppers during a VR shopping session, including a user and at least one additional shopper;
determining by the computer, that the product has an available quantity value below a predetermined warning threshold, based at least in part on a comparison of an in-stock quantity of said product and an indicated purchase quantity preference associated with said interested shoppers for said product;
responsive to said determination, identifying by the computer, a product popularity value representing, at least in part, a quantity associated with said group of interested shoppers; and
displaying by the computer, in said VR shopping environment to said user, said product popularity value.

2. The method of claim 1, wherein said product popularity value further represents the indicated purchase quantity preference.

3. The method of claim 1, wherein said product popularity value further includes, a purchase likelihood category associated with the at least one additional shopper.

4. The method of claim 1, wherein said product popularity value further includes a purchase probability associated with the at least one additional shopper, said purchase probability generated by a Machine Learning (ML) model trained to predict shopping activity of interested shoppers applied to shopper history metadata associated with said at least one additional shopper available to the computer.

5. The method of claim 1, further displaying by said computer, in said VR shopping environment to said user, a product stock replenishment date based, at least in part, on supply chain metadata available to the computer.

6. The method of claim 1, further including presenting by the computer to said user for consideration, an item identified by said computer as a substitute candidate for the product selected.

7. The method of claim 1, further including presenting by the computer to said user an indication of a user relative queue position within said group of interested shoppers.

8. The method of claim 7, further including:
determining at least one of a change to said available quantity and to said user relative queue position during the VR shopping session and displaying by said computer, in said VR shopping environment to said user, an alert indicating said at least one change.

9. A system to indicate to a user in a virtual reality shopping session, aspects of availability for a selected item, which comprises:
a computer system comprising a computer readable storage medium having program instructions embodied therewith, the program instructions executable by a computer to cause the computer to:
identify in a virtual reality (VR) shopping environment, a product selected for consideration by a group of interested shoppers during a VR shopping session, including a user and at least one additional shopper;
determine that the product has an available quantity value below a predetermined warning threshold, based at least in part on a comparison of an in-stock quantity of said product and an indicated purchase quantity preference associated with said interested shoppers for said product;
responsive to said determination, identifying a product popularity value representing, at least in part, a quantity associated with said group of interested shoppers; and
display in said VR shopping environment to said user, said product popularity value.

10. The system of claim 9, wherein said product popularity value further represents the indicated purchase quantity preference.

11. The system of claim 9, wherein said product popularity value further includes, a purchase likelihood category associated with the at least one additional shopper.

12. The system of claim 9, wherein said product popularity value further includes a purchase probability associated with the at least one additional shopper, said purchase probability generated by a Machine Learning (ML) model trained to predict shopping activity of interested shoppers applied to shopper history metadata associated with said at least one additional shopper available to the computer.

13. The system of claim 9, further displaying by said computer, in said VR shopping environment to said user, a product stock replenishment date based, at least in part, on supply chain metadata available to the computer.

14. The system of claim 9, further including presenting to said user for consideration, an item identified by said computer as a substitute candidate for the product selected.

15. The system of claim 9, further including presenting to said user an indication of a user relative queue position within said group of interested shoppers.

16. The system of claim 15, further including:
determining at least one of a change to said available quantity and to said user relative queue position during the VR shopping session and displaying by said computer, in said VR shopping environment to said user, an alert indicating said at least one change.

17. A computer program product to indicate to a user in a virtual reality shopping session, aspects of availability for a selected item, the computer program product comprising a computer readable storage medium having program instructions embodied therewith, the program instructions executable by a computer to cause the computer to:
identify in a virtual reality (VR) shopping environment, a product selected for consideration by a group of interested shoppers during a VR shopping session, including a user and at least one additional shopper;
determine that the product has an available quantity value below a predetermined warning threshold, based at least in part on a comparison of an in-stock quantity of said product and an indicated purchase quantity preference associated with said interested shoppers for said product;
responsive to said determination, identifying a product popularity value representing, at least in part, a quantity associated with said group of interested shoppers; and
display in said VR shopping environment to said user, said product popularity value.

18. The computer program product of claim 17, wherein said product popularity value further includes a purchase probability associated with the at least one additional shopper, said purchase probability generated by a Machine Learning (ML) model trained to predict shopping activity of interested shoppers applied to shopper history metadata associated with said at least one additional shopper available to the computer.

19. The computer program product of claim 17, further including presenting, using the computer, to said user an indication of a user relative queue position within said group of interested shoppers.

20. The computer program product of claim 19, further including:
determining, using the computer, at least one of a change to said available quantity and to said user relative queue position during the VR shopping session and displaying by said computer, in said VR shopping environment to said user, an alert indicating said at least one change.
